(19) United States
(12) Patent Application Publication
(10) Pub. No.: US 2025/0043888 A1
(43) Pub. Date: Feb. 6, 2025

(54) CABLE HANGER AND CABLE MANAGEMENT SYSTEM INCLUDING SAME

(71) Applicant: Cambria County Association for the Bind & Handicapped

(72) Inventor: JASON RICHARD MARTINAGE, South Fork, PA (US)

(73) Assignee: Cambria County Association for the Blind & Handicapped, (omitted)

(21) Appl. No.: 18/793,011

(22) Filed: Aug. 2, 2024

Related U.S. Application Data
(60) Provisional application No. 63/530,558, filed on Aug. 3, 2023.
(60) Provisional application No. 63/530,742, filed on Aug. 4, 2023.

(51) Int. Cl. F16L 3/22; H02G 3/30

(52) U.S. Cl. CPC F16L 3/22; H02G 3/30

(57) ABSTRACT

A cable hanger for use in supporting a plurality of pairs of electrical cables from a messenger wire in a spaced configuration, the cable hanger includes an arrangement structured to be engaged with the messenger wire in a manner such that the cable hanger is suspended from the messenger wire. The cable hanger further includes a plurality of carrier portions, each carrier portion being structured to support a respective pair of electrical cables of the plurality of pairs of electrical cables. The carrier portions are disposed in a spaced array having at least three columns and a plurality of rows.

### CROSS REFERENCE TO RELATED APPLICATION

This application claims priority to U.S. Provisional Patent Application Ser. Nos. 63/530,558 filed Aug. 3, 2023, and 63/530,742 filed Aug. 4, 2023, the contents of each are incorporated by reference herein.

### FIELD OF THE INVENTION

The disclosed concept relates generally to cable hangers for managing cables. More particularly, the disclosed concept relates to cable hangers for hanging on a messenger wire and supporting/managing cables strung along generally the same route as the messenger wire. Even more particularly, the disclosed concept relates to cable hangers for use in supporting/managing electrical cables, such as DC power cables, associated with solar power generating arrangements.

### BACKGROUND OF THE INVENTION

There are many environments/situations in which cables, such as those used to convey electrical current, need to be strung in an organized manner. For example, in large-scale solar power plants, various quantities of cables, such as DC power cables (commonly in pairs), are utilized to convey electrical current generated by solar panels from the solar panels to production and/or transmission equipment within the plant. Other cables conveying current and/or signal data to/from various equipment are also commonly utilized. Commonly assigned U.S. Pat. Nos. 9,722,405 and 10,177,551, the contents of which are incorporated by reference herein, describe some above-ground arrangements that have been utilized to manage/support/organize cables used in solar power plants. While such solutions have greatly improved upon previous solutions, there is still room for improvement.

### SUMMARY OF THE INVENTION

Shortcomings of previous solutions are addressed by aspects of the disclosed concept. As one of such aspects of the disclosed concept, a cable hanger for use in supporting a plurality of pairs of electrical cables from a messenger wire in a spaced configuration is provided. The cable hanger comprises: an arrangement structured to be engaged with the messenger wire in a manner such that the cable hanger is suspended from the messenger wire; and a plurality of carrier portions, each carrier portion being structured to support a respective pair of electrical cables of the plurality of pairs, wherein the plurality of carrier portions are disposed in a spaced array having at least three columns and a plurality of rows.

Each carrier portion may be sized and configured so as to support the respective pair of electrical cables in a stacked configuration. The arrangement may comprise at least one hook member structured to hook around the messenger wire. The arrangement may comprise a pair of overlapping hook members structured to hook around the messenger wire. The spaced array may comprise at least four columns. The plurality of rows may comprise at least three rows. Each of the carrier portions may be structured to support a pair of DC electrical cables. The spaced array may comprise a plurality of rows, and the spaced array may comprise at least four columns. The arrangement may comprise at least one hook member structured to hook around the messenger wire. The arrangement may comprise at least two hook members structured to hook around the messenger wire. The cable hanger may be formed from a high tensile strength wire.

The cable hanger may further comprise: a primary hanger comprising the arrangement structured to be engaged with the messenger wire; and a secondary hanger structured to be coupled to the primary hanger by a number of connection elements, wherein the primary hanger comprises a first plurality of the plurality of carrier portions, and wherein the secondary hanger comprises a second plurality of the plurality of carrier portions. The number of connection elements may comprise a plurality of hook members. The secondary hanger may be coupled to the primary hanger by the number of connection elements. The cable hanger may further comprise: a further secondary hanger structured to be coupled to the secondary hanger by a number of further connection elements, wherein the further secondary hanger comprises a third plurality of the plurality of carrier portions. The number of further connection elements may comprise another plurality of hook members. The cable hanger may further comprise: a further secondary hanger coupled to the secondary hanger by a number of further connection elements, wherein the further secondary hanger comprises a third plurality of the plurality of carrier portions.

As another aspect of the disclosed concept a cable management system for use in managing a plurality of pairs of electrical cables is provided. The cable management system comprises: a messenger wire structured to be suspended a distance above the ground; and a plurality of cable hangers, each cable hanger comprising: an arrangement structured to be engaged with the messenger wire in a manner such that the cable hanger is suspended from the messenger wire; and a plurality of carrier portions, each carrier portion being structured to support a respective pair of electrical cables of the plurality of pairs, wherein the plurality of carrier portions are disposed in a spaced array having at least three columns and a plurality of rows.

The messenger wire may be suspended a distance above the ground and the arrangement structured to be engaged with the messenger wire may be engaged with the messenger wire. Each carrier portion may be sized and configured so as to support the respective pair of electrical cables in a stacked configuration. The arrangement may comprise at least one hook member structured to hook around the messenger wire. The arrangement may comprise a pair of overlapping hook members structured to hook around the messenger wire. The spaced array may comprise at least four columns. The plurality of rows may comprise at least three rows. Each cable hanger may further comprise: a primary hanger comprising the arrangement structured to be engaged with the messenger wire; and a secondary hanger structured to be coupled to the primary hanger by a number of connection elements, wherein the primary hanger comprises a first plurality of the plurality of carrier portions, and wherein the secondary hanger comprises a second plurality of the plurality of carrier portions. The number of connection elements may comprise a plurality of hook members. The secondary hanger may be coupled to the primary hanger by the number of connection elements. Each cable hanger may further comprise: a further secondary hanger structured to be coupled to the secondary hanger by a number of further connection elements, wherein the further secondary hanger comprises a third plurality of the plurality of carrier portions. The number of further connection elements may comprise another plurality of hook members. Each cable hanger may further comprise: a further secondary hanger coupled to the secondary hanger by a number of further connection elements, wherein the further secondary hanger comprises a third plurality of the plurality of carrier portions. Each of the carrier portions may be structured to support a pair of DC electrical cables. The spaced array may comprise a plurality of rows and at least four columns. Each cable hanger may be formed from a high tensile strength wire.

As yet another aspect of the disclosed concept, a method of organizing a plurality of DC power cables is provided. The method comprises: suspending a plurality of cable hangers along a messenger wire provided a distance in the air; and placing a plurality of pairs of the DC power cables in respective carrier portions of each cable hanger of the plurality of cable hangers, wherein the carrier portions of each cable hanger of the plurality of cable hangers are disposed in a spaced array having at least three columns and a plurality of rows.

Placing the plurality of pairs of the DC power cables in respective carrier portions of each cable hanger of the plurality of cable hangers may comprise placing each pair of DC power cables in the respective carrier portion in a stacked configuration.

These and other objects, features, and characteristics of the disclosed concept, as well as the methods of operation and functions of the related elements of structure and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are provided for the purpose of illustration and description only and are not intended as a definition of the limits of the disclosed concept.

### BRIEF DESCRIPTION OF THE DRAWINGS

A full understanding of the invention can be gained from the following description of the preferred embodiments when read in conjunction with the accompanying drawings in which:

FIG. 1 is a perspective view of two cable hangers in accordance with an example embodiment of the disclosed concept shown arranged along a messenger wire with two pairs of electrical cables positioned thereon thus forming a cable management system in accordance with an example embodiment of the disclosed concept;

FIG. 2 is a front elevation view of one of the cable hangers of FIG. 1 shown with twelve pairs of electrical cables (shown schematically) positioned thereon;

FIG. 3 is an exploded perspective view of one of the cable hangers of FIGS. 1 and 2;

FIG. 4 is a side elevation view of a secondary hanger of the cable hanger of FIGS. 1-3;

FIG. 5 is a front elevation view of a secondary hanger of the cable hanger of FIGS. 1-3;

FIG. 6 is a perspective view of a cable hanger in accordance with another example embodiment of the disclosed concept shown engaged with a messenger wire;

FIG. 7 is a front elevation view of the cable hanger of FIG. 6 shown with twelve pairs of electrical cables (shown schematically) positioned thereon; and

FIG. 8 is an exploded perspective view of the cable hanger of FIGS. 6 and 7.

### DETAILED DESCRIPTION OF THE PREFERRED EMBODIMENTS

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, and as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the phrase “removably coupled” or “temporarily coupled” means that one component is coupled with another component in an essentially temporary manner. That is, the two components are coupled in such a way that the joining or separation of the components is easy and would not damage the components. For example, two components secured to each other with a limited number of readily accessible fasteners, i.e., fasteners that are not difficult to access, are “removably coupled” whereas two components that are welded together or joined by difficult to access fasteners are not “removably coupled.” A “difficult to access fastener” is one that requires the removal of one or more other components prior to accessing the fastener wherein the “other component” is not an access device such as, but not limited to, a door.

As used herein, the term “number” shall mean one or an integer greater than one (i.e., a plurality). Thus, for example, a “number of elements” means one element or a plurality of elements.

Embodiments of the disclosed concept provide solutions for managing electrical cables, such as DC power cables employed in solar power generation, in a manner which spaces the cables so as to minimize heating effects resulting from adjacent cables and allows for the elimination of cable derating. By minimizing such effects, smaller, easier to maneuver, less costly cables can be employed in a particular installation as compared to arrangements wherein such heating effects are not addressed.

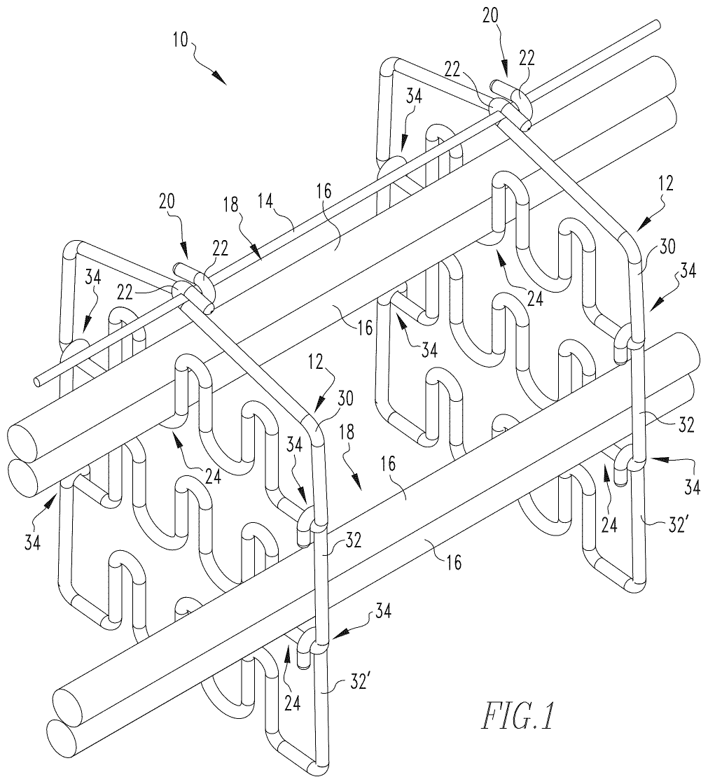

A perspective view of a cable management system 10 in accordance with an example embodiment of the disclosed concept is shown in FIG. 1. System 10 includes a plurality of cable hangers 12 that are each suspended/hanging from a messenger wire 14 that is suspended a distance above the ground. In an example embodiment of the disclosed concept employed in a solar power plant, messenger wire 14 may be strung a distance above the ground between piers or other suitable structures supporting the solar panels or other arrangements of the solar power plant. Depending on the application, messenger wire 14 may be a multifunction line, e.g., such as described in previously mentioned U.S. Pat. No. 10,177,551, and thus composed of suitable materials to be utilized as a ground wire in addition to supporting hanger arrangements 14 without varying from the scope of the disclosed concept. Each of cable hangers 12 is structured to manage (i.e., hold/support) a plurality of electrical cables 16 in a predetermined arrangement manner. In the example shown in FIG. 1, portions of four electrical cables 16 grouped together in two pairs 18 are shown positioned among hanger arrangements 12, however, it is to be appreciated that one or more of the quantity and/or positioning of the electrical cables 16 may be varied without varying from the scope of the disclosed concept. In such example, electrical cables 16 are DC power cables such as those commonly employed in solar power generation. Some example sizes of such DC power cables that may be supported by particular example embodiments of the disclosed concept are, without limitation, 250 kcmil, 350 kcmil, 500 kcmil, 600 kcmil, 750 kcmil, and 1000 kcmil.

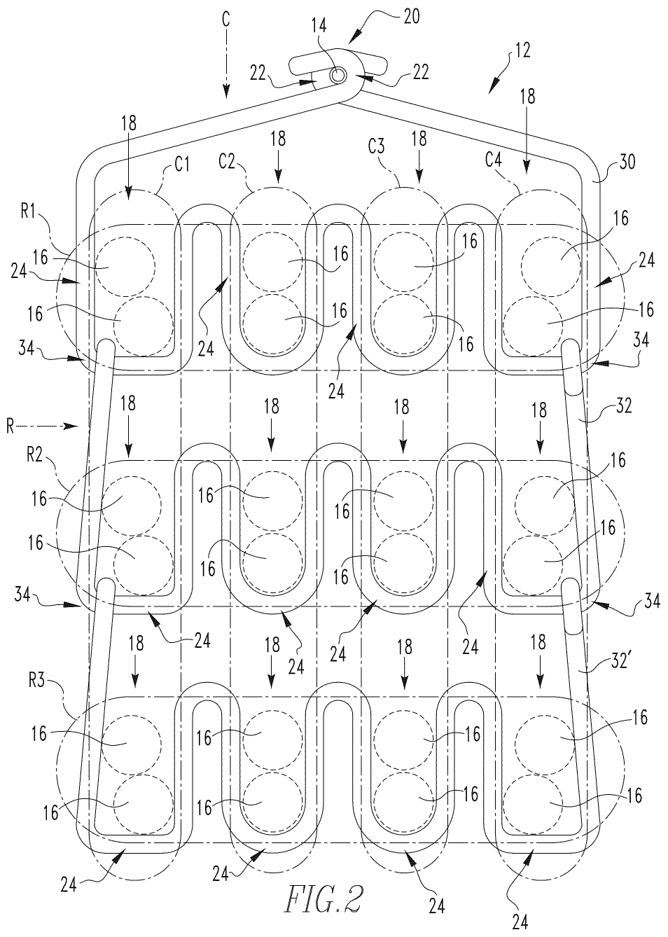

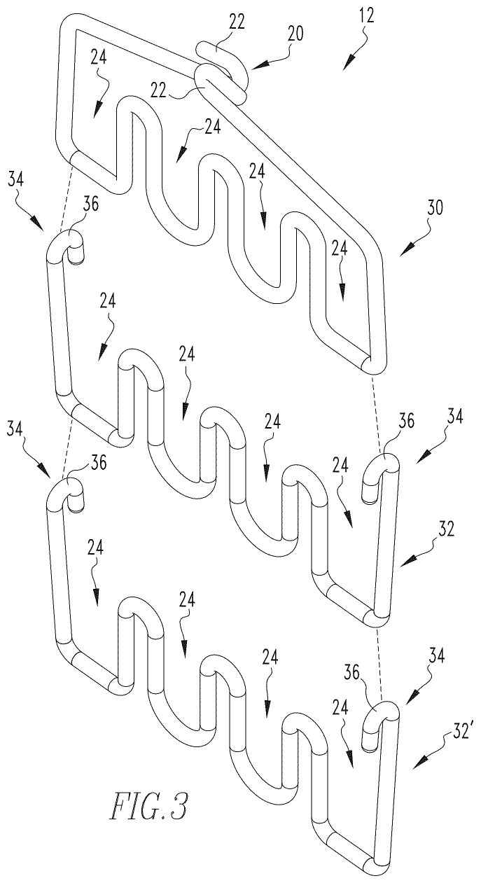

Referring now to FIGS. 2 and 3, in addition to FIG. 1, each cable hanger 12 generally includes an arrangement 20 structured to be engaged with the messenger wire 14 in a manner such that the cable hanger 12 may be hung/suspended from and/or coupled to the messenger wire 14. In some example embodiments of the disclosed concept, one or more hook members 22 structured to hook around messenger wire 14 have been employed for arrangement 20. For example, in the embodiment shown in FIGS. 1-3, arrangement 20 includes two hook portions 22 that generally hook in opposed directions about messenger wire 14, thus completely encircling messenger wire 14 and coupling cable hanger 12 thereto. However, it is to be appreciated that other suitable arrangements may be employed for engaging/coupling cable hanger 12 with messenger wire 14 without varying from the scope of the disclosed concept.

Continuing to refer to FIGS. 1-3, cable hanger 12 further includes a plurality of carrier portions 24, with each carrier portion 24 being structured to support a respective pair 18 of the plurality of electrical cables 16. As shown in FIG. 2, the plurality of carrier portions 24 are disposed in a spaced array (not numbered) having a plurality of vertical columns C and horizontal rows R (when cable hanger 12 is viewed hanging below messenger wire 14 such as shown in such Figure). As used herein, the phrase “spaced array” means an arrangement wherein the arrayed items (i.e., carrier portions 24 and thus the pairs 18 of cables 16 disposed therein) are positioned so as to have predetermined gaps or air spaces between adjacent items so as to provide for dissipation of possible heat from the cables 16 created due to the passage of current therethrough. By providing for such heat dissipation cable derating may be avoided, and thus smaller sized cables may be employed for carrying a given current as compared to cables that are bunched together.

In the example embodiment shown in FIG. 2, the spaced array includes four columns C1-C4 and three rows R1-R3, however, it is to be appreciated that such quantities may be varied without varying from the scope of the disclosed concept. For example, embodiments of the disclosed concept employing as few as three columns and two rows have been employed. Two particular non-limiting examples for accommodating 12 pairs of DC cables in different arrangements are described herein. As also shown in the example of FIG. 2, each carrier portion 24 may be sized and configured so as to support the respective pair 18 of electrical cables 16 in a stacked configuration. As used herein, the phrase “stacked configuration” means an arrangement wherein two cables are placed one on top of the other such that the center of the top cable overlies the bottom cable when such cables are viewed in cross-section (e.g., such as shown in the example of FIG. 2). It is to be appreciated that in such example each carrier portion 24 is sized and configured to carry therein only two cables, such as two of the DC cables of sizes previously discussed. It is also to be appreciated that while the example embodiments discussed herein employ carrier portions 24 that are generally u-shaped and rectangular shaped, it is to be appreciated that carrier portions 24 of other shapes may be employed without varying from the scope of the disclosed concept.

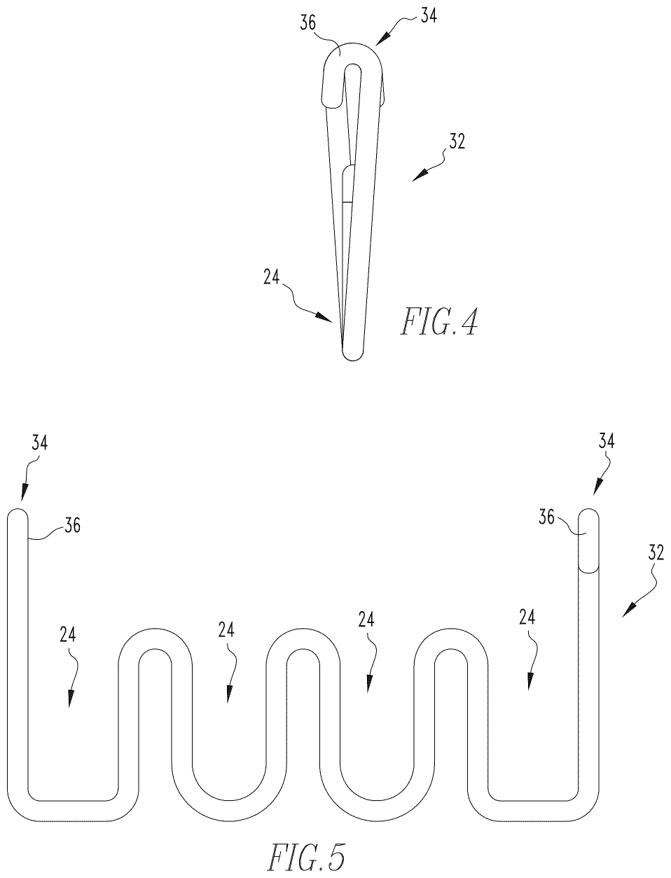

In the example shown in FIGS. 1-3, cable hanger 12 is of modular construction and includes a primary hanger 30, and a number of secondary hangers 32. As shown in FIGS. 1 and 2, primary hanger 30 is directly engaged with messenger wire 14 and thus directly engages messenger wire 14. In such example, primary hanger 30 may be engaged with/coupled to messenger wire 14 by first hooking one of hook members 22 about messenger wire 14 and then subsequently slightly bending primary hanger 14 such that the other hook member 22 hooks about messenger wire 14. Such process is simply reversed if removal of primary hanger 30 from messenger wire 14 is desired. As shown in FIGS. 1 and 2, each secondary hanger 32 is selectively coupled, directly or indirectly, to primary hanger 30 by a number of connection elements 34. In the illustrated example, cable hanger 12 includes two secondary hangers 32, 32′, with a first secondary hanger 32 directly coupled to primary hanger 30, and a second secondary hanger 32′ indirectly coupled to primary hanger 30 via the first secondary hanger 32. As shown further in FIGS. 4 and 5, in such example, each secondary hanger 32 includes a pair of connection elements 34 in the form of hook members 36 positioned to hook about another hanger (i.e., connection elements 34 of first secondary hanger 32 hook about portions of primary hanger 30, while connection elements 34 of second secondary hanger 32′ hook about portions of first secondary hanger 32). It is to be appreciated that one or more of the quantity, coupling arrangement, coupling mechanism, and/or sizing of the secondary hangers 32 may be varied without varying from the scope of the disclosed concept. Further, in the example shown in FIGS. 1-5, each of primary and secondary hangers 30 and 32 are formed from a formed wire that was subsequently coated (e.g., similar to the construction described in commonly assigned U.S. Pat. No. 9,722,405), however, it is to be appreciated that one or more of the fabrication/construction of hanger 12 and/or hangers 30, 32 may be varied, as well as the presence (or lack thereof) of any coating or coatings may be varied without varying from the scope of the disclosed concept.

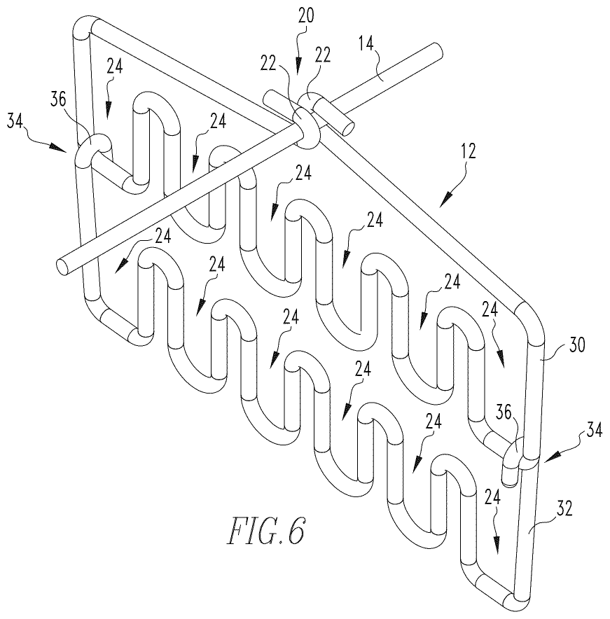

FIGS. 6-8 show views of another example cable hanger 12 in which some of the aforementioned details of cable hanger 12 from FIGS. 1-3 have been varied for exemplary purposes.

In general terms, a method of organizing a plurality of DC power cables 16 in accordance with an example embodiment of the disclosed concept includes: suspending a plurality of cable hangers 12 along messenger wire 14 provided a distance in the air; and placing a plurality of pairs 18 of the DC power cables 16 in respective carrier portions 24 of each cable hanger 12 of the plurality of cable hangers 12, wherein the carrier portions 24 of each cable hanger of the plurality of cable hangers 12 are disposed in a spaced array having at least three columns C and a plurality of rows R.

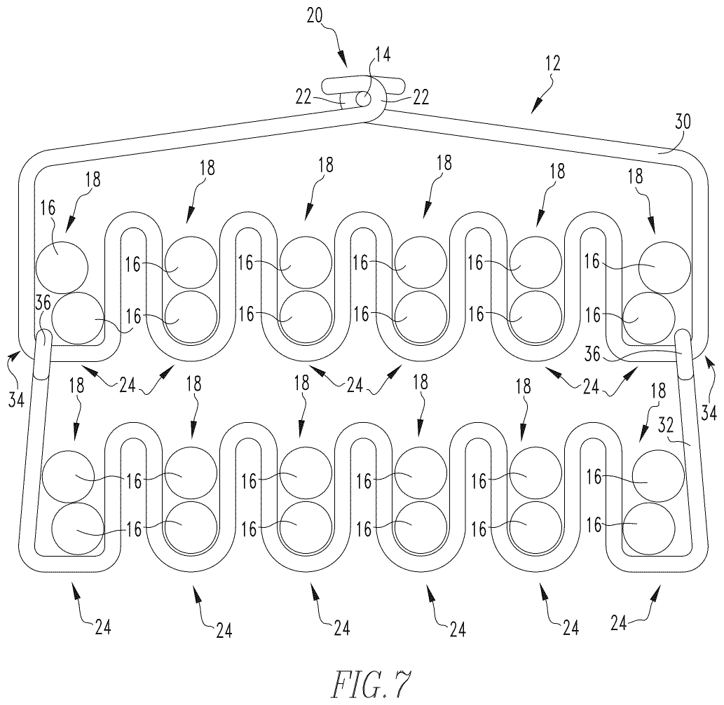

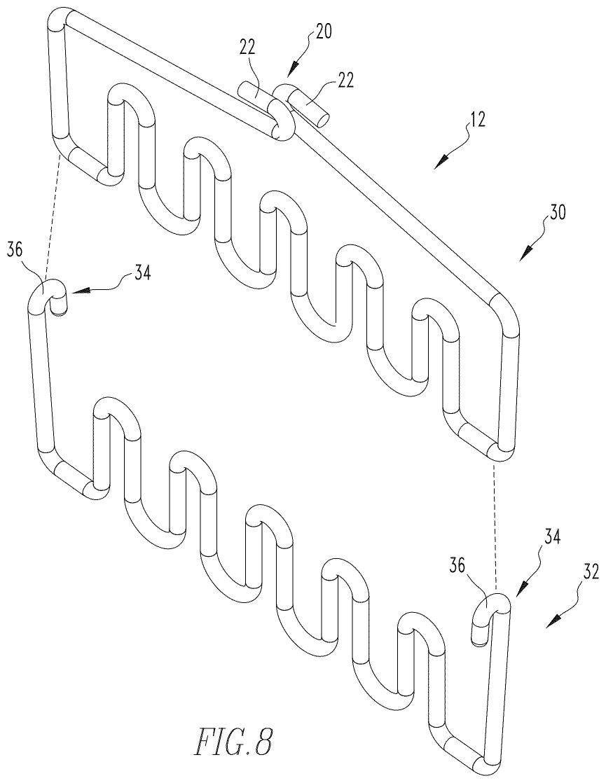

In an example installation in which a plurality of example cable hangers 12 such as illustrated herein are utilized, messenger cable 14 would first be positioned in a desired position (e.g., secured a desired height above the ground). Next, primary hangers 30 would be coupled to messenger wire 14 via one of hook portions 22 of arrangement 20. Next, cables 16 would be positioned in/on carrier portions 24 of primary hanger 30 as desired. Once complete, the second hook portion 22 of arrangement 20 of primary hanger 30 would be coupled to messenger wire 14. Next, first secondary hanger 32 is coupled to primary hanger 30 via one of hooks members 36 such that first secondary hanger 32 hangs generally diagonally below primary hanger 30. Next, cables 16 would be positioned in/on carrier portions 24 of first secondary hanger 32 as desired. Once complete, the second of hooks members 36 secondary hanger 22 would be coupled to primary hanger 18. The same process would then be repeated by (partially) coupling the second secondary hanger 32′ to the first secondary hanger 32, positioning further cables 16, and then (fully) coupling the second secondary hanger 22 to the first secondary hanger 22. It is to be appreciated that such general method would provide for each cable 16 to generally be laid in hanger arrangement 12, preferably in pairs such as shown in the examples view of FIGS. 2 and 7.

In another example installation, cable hanger 12 (as a modular or unitary hanger) is installed as generally shown in FIG. 1 on messenger wire 14 and then cables 16 are placed thereon/therein hanger arrangement 12 by generally stringing the cables therethough (e.g., similar to threading a needle) or via any other suitable means depending on the particular fabrication of cable hanger 12.

In addition, in yet another example installation, a combination of the above methods may be employed wherein some of the cables 16 are placed in a generally “open” (i.e., partially coupled one or more of hangers 30, 32, etc.) while other cables are strung through one or more fully coupled hangers 30, 32, etc.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

From the foregoing it can thus be readily appreciated that embodiments of the disclosed concept provide cable management solutions which readily provide controlled, predetermined spacing for cables, and cable pairs in installations such as those commonly encountered in solar power generation and related fields.

In the claims, any reference signs placed between parentheses shall not be construed as limiting the claim. The word “comprising” or “including” does not exclude the presence of elements or steps other than those listed in a claim. In any device claim enumerating several means, several of these means may be embodied by one and the same item of hardware. The word “a” or “an” preceding an element does not exclude the presence of a plurality of such elements. The mere fact that certain elements are recited in mutually different dependent claims does not indicate that these elements cannot be used in combination.

What is claimed is:

1. A cable hanger for use in supporting a plurality of pairs of electrical cables from a messenger wire in a spaced configuration, the cable hanger comprising:
an arrangement structured to be engaged with the messenger wire in a manner such that the cable hanger is suspended from the messenger wire; and
a plurality of carrier portions, each carrier portion being structured to support a respective pair of electrical cables of the plurality of pairs,
wherein the plurality of carrier portions are disposed in a spaced array having at least three columns and a plurality of rows.

2. The cable hanger of claim 1, wherein each carrier portion is sized and configured so as to support the respective pair of electrical cables in a stacked configuration.

3. The cable hanger of claim 1, wherein the arrangement comprises at least one hook member structured to hook around the messenger wire.

4. The cable hanger of claim 1, wherein the arrangement comprises a pair of overlapping hook members structured to hook around the messenger wire.

5. The cable hanger of claim 1, wherein the spaced array comprises at least four columns.

6. The cable hanger of claim 1, wherein the plurality of rows comprises at least three rows.

7. The cable hanger of claim 1, further comprising:
a primary hanger comprising the arrangement structured to be engaged with the messenger wire; and
a secondary hanger structured to be coupled to the primary hanger by a number of connection elements,
wherein the primary hanger comprises a first plurality of the plurality of carrier portions, and
wherein the secondary hanger comprises a second plurality of the plurality of carrier portions.

8. The cable hanger of claim 7, wherein the number of connection elements comprises a plurality of hook members.

9. The cable hanger of claim 7, wherein the secondary hanger is coupled to the primary hanger by the number of connection elements.

10. The cable hanger of claim 7, further comprising:
a further secondary hanger structured to be coupled to the secondary hanger by a number of further connection elements,
wherein the further secondary hanger comprises a third plurality of the plurality of carrier portions.

11. The cable hanger of claim 10, wherein the number of further connection elements comprises another plurality of hook members.

12. The cable hanger of claim 9, further comprising:
a further secondary hanger coupled to the secondary hanger by a number of further connection elements,
wherein the further secondary hanger comprises a third plurality of the plurality of carrier portions.

13. The cable hanger of claim 1, wherein each of the carrier portions are structured to support a pair of DC electrical cables.

14. The cable hanger of claim 1, wherein the spaced array comprises a plurality of rows, and wherein the spaced array comprises at least four columns.

15. The cable hanger of claim 13, wherein the arrangement comprises at least one hook member structured to hook around the messenger wire.

16. The cable hanger of claim 13, wherein the arrangement comprises at least two hook members structured to hook around the messenger wire.

17. The cable hanger of claim 1, wherein the cable hanger is formed from a high tensile strength wire.

18. A cable management system for use in managing a plurality of pairs of electrical cables, the cable management system comprising:
a messenger wire structured to be suspended a distance above the ground; and
a plurality of cable hangers, each cable hanger comprising:
an arrangement structured to be engaged with the messenger wire in a manner such that the cable hanger is suspended from the messenger wire; and
a plurality of carrier portions, each carrier portion being structured to support a respective pair of electrical cables of the plurality of pairs,
wherein the plurality of carrier portions are disposed in a spaced array having at least three columns and a plurality of rows.

19. The cable management system of claim 18, wherein the messenger wire is suspended a distance above the ground, and wherein the arrangement structured to be engaged with the messenger wire is engaged with the messenger wire.

20. The cable management system of claim 18, wherein each carrier portion is sized and configured so as to support the respective pair of electrical cables in a stacked configuration.

21. The cable management system of claim 18, wherein the arrangement comprises at least one hook member structured to hook around the messenger wire.

22. The cable management system of claim 18, wherein the arrangement comprises a pair of overlapping hook members structured to hook around the messenger wire.

23. The cable management system of claim 18, wherein the spaced array comprises at least four columns.

24. The cable management system of claim 18, wherein the plurality of rows comprises at least three rows.

25. The cable management system of claim 18, wherein each cable hanger further comprises:
a primary hanger comprising the arrangement structured to be engaged with the messenger wire; and
a secondary hanger structured to be coupled to the primary hanger by a number of connection elements,
wherein the primary hanger comprises a first plurality of the plurality of carrier portions, and
wherein the secondary hanger comprises a second plurality of the plurality of carrier portions.

26. The cable management system of claim 25, wherein the number of connection elements comprises a plurality of hook members.

27. The cable management system of claim 25, wherein the secondary hanger is coupled to the primary hanger by the number of connection elements.

28. The cable management system of claim 25, wherein each cable hanger further comprises:
a further secondary hanger structured to be coupled to the secondary hanger by a number of further connection elements,
wherein the further secondary hanger comprises a third plurality of the plurality of carrier portions.

29. The cable management system of claim 28, wherein the number of further connection elements comprises another plurality of hook members.

30. The cable management system of claim 25, wherein each cable hanger further comprises:
a further secondary hanger coupled to the secondary hanger by a number of further connection elements,
wherein the further secondary hanger comprises a third plurality of the plurality of carrier portions.

31. The cable management system of claim 18, wherein each of the carrier portions are structured to support a pair of DC electrical cables.

32. The cable management system of claim 18, wherein the spaced array comprises a plurality of rows, and wherein the spaced array comprises at least four columns.

33. The cable management system of claim 18, wherein each cable hanger is formed from a high tensile strength wire.

34. A method of organizing a plurality of DC power cables comprises:
suspending a plurality of cable hangers along a messenger wire provided a distance in the air; and
placing a plurality of pairs of the DC power cables in respective carrier portions of each cable hanger of the plurality of cable hangers,
wherein the carrier portions of each cable hanger of the plurality of cable hangers are disposed in a spaced array having at least three columns and a plurality of rows.

35. The method of claim 34, wherein placing the plurality of pairs of the DC power cables in respective carrier portions of each cable hanger of the plurality of cable hangers comprises placing each pair of DC power cables in the respective carrier portion in a stacked configuration.
